(19) United States
(12) Patent Application Publication
(10) Pub. No.: US 2013/0023395 A1
(43) Pub. Date: Jan. 24, 2013

(54) FILTER MANUFACTURING MACHINE

(71) Applicant: Satoshi NAKAMURA, Tokyo (JP)

(72) Inventor: Satoshi NAKAMURA, Tokyo (JP)

(21) Appl. No.: 13/618,611

(22) Filed: Sep. 14, 2012

Related U.S. Application Data
(63) Continuation of application No. PCT/JP2010/054430, filed on Mar. 16, 2010.

(51) Int. Cl. B31B 1/62

(52) U.S. Cl. 493/328

(57) ABSTRACT

A filter manufacturing machine includes a feed path (7) configured to continuously feed a sheet material containing filter fibers and provided with a first plasticizer addition unit (9); a forming device (3) connected to a terminating end of the feed path (7) and configured to form the sheet material (6) into a hollow rod-shaped continuous filter body (11), the forming device including a tubular forming path for forming the sheet material (6) into the continuous filter body (11), a heat treating section for heating the sheet material, and a second plasticizer addition unit (14) arranged near the inlet of the tubular forming path; and a wrapping device (4) configured to receive the continuous filter body (11) delivered from the forming device (3) and wrap the continuous filter body in a wrapper to form a filter rod (19).

### TECHNICAL FIELD

The present invention relates to a filter manufacturing machine for making hollow filters from filter fibers.

### BACKGROUND ART

A conventional filter manufacturing machine includes a storage vessel storing acetate tow for use as filter fibers, for example, and the tow (filter fibers) is fed from the storage vessel along a predetermined feed path. In the process of feeding, the tow is opened, spread, and formed into a sheet material. Subsequently, a plasticizer such as triacetin is added to the sheet material, and the sheet material is supplied to a rod forming device. In the rod forming device, the sheet material is formed into a rod, and the rod-shaped material is wrapped in paper to continuously form a filter rod.

The sheet material is formed into a rod by means of a part called forming tube. While passing through the forming tube, the sheet material is compressed and formed into a rod. There has been known a conventional technique whereby the sheet material is formed into a hollow cylindrical rod while passing through the forming tube.

In order to make a through hole in the rod, a mandrel is previously arranged inside the forming tube along the axis of the forming tube. The sheet material introduced into the forming tube is formed into a rod around the mandrel, continuously delivered, and pulled out of the mandrel, whereupon the rod with a through hole is obtained. It is, however, often the case that the tow projects from the surface of the through hole, and a filter rod with such a through hole is regarded as low in quality and rejected as a defective article. Also, if the surface region of the through hole of the rod is not satisfactorily high in hardness, the through hole is crushed when the filter rod is cut in a subsequent process, leading to lowering of the quality. In order to prevent crushing of the through hole, the amount of the plasticizer used may be increased to thereby increase the hardness of the filter. If the plasticizer is used in a large amount, however, a problem arises in that the filter itself is dissolved or gives off an offensive smell.

On the other hand, Patent Document 1 discloses an apparatus for manufacturing a hollow cylindrical filter rod. In this manufacturing apparatus, a tube is arranged along the axis of a filter rod to be formed, and tow is gathered around the tube and hardened to form a hollow filter. The apparatus, however, requires an additional member, namely, the tube, which leads to increase in the number of component parts. Also, a tube feed mechanism needs to be additionally provided, making the apparatus and its control complex.

### PRIOR ART LITERATURE

### Patent Document

Patent Document 1: U.S. Pat. No. 3,095,343

### SUMMARY OF THE INVENTION

### Problems to be Solved by the Invention

The present invention was made in view of the aforementioned conventional techniques, and an object thereof is to provide a filter manufacturing machine capable of manufacturing a filter in such a manner that tow is prevented from projecting from the surface of a through hole without the need to use a large amount of plasticizer and also that the through hole is not crushed when the filter is cut.

### Means for Solving the Problems

To achieve the above object, the present invention provides a filter manufacturing machine comprising: a feed path configured to continuously feed a sheet material containing filter fibers; a first plasticizer addition unit arranged in the feed path and configured to add a first plasticizer to the sheet material on the feed path; a forming device connected to a terminating end of the feed path and configured to form the sheet material into a hollow rod-shaped continuous filter body and deliver the formed continuous filter body, the forming device including a tubular forming path allowing the sheet material to pass therethrough while narrowing the sheet material to form the sheet material into the continuous filter body, a heat treating section configured to heat the sheet material while the sheet material passes through the tubular forming path, and a second plasticizer addition unit arranged near an inlet of the tubular forming path and configured to spout a second plasticizer radially from an axis of the tubular forming path to add the second plasticizer to the sheet material; and a wrapping device configured to receive the continuous filter body delivered from the forming device, wrap the continuous filter body in a wrapper to form a filter rod, and cut the filter rod to obtain filter plugs.

Preferably, the forming device further includes a forming tube and a mandrel arranged inside the forming tube and cooperating with the forming tube to constitute the tubular forming path, the mandrel has one end portion located near an inlet of the forming tube, and the second plasticizer addition unit has a spray nozzle attached to the one end portion of the mandrel to spray the second plasticizer from the spray nozzle.

The second plasticizer is preferably sprayed from the spray nozzle in a forward direction of the tubular forming path.

Preferably, the forming tube has a peripheral wall through which a hole is formed to supply steam to the sheet material from outside of the forming tube.

The spray nozzle is preferably located upstream of the hole for supplying the steam, with respect to a direction in which the sheet material passes.

Preferably, the tubular forming path has a rounded configuration such that a diameter of an inlet section thereof gradually increases toward the inlet of the tubular forming path.

The second plasticizer is preferably sprayed only on a portion of the sheet material which comes into contact with the mandrel.

Preferably, the forming device includes a forming tube and a mandrel arranged inside the forming tube and cooperating with the forming tube to constitute the tubular forming path, and the mandrel includes a plasticizer flow channel axially extending therein to allow the second plasticizer to flow therein, a peripheral wall defining the plasticizer flow channel, and a plurality of jet holes formed through the peripheral wall to spout the second plasticizer therethrough.

### Advantageous Effects of the Invention

According to the present invention, the forming tube is associated with the second plasticizer addition unit, and the second plasticizer is spouted outward from the axis of the forming tube. Consequently, the second plasticizer is added only to that portion of the sheet material which is to form the surface of a through hole of the hollow continuous filter body. In this manner, the second plasticizer addition unit for adding the second plasticizer to the sheet material is provided separately from the first plasticizer addition unit for adding the first plasticizer, and therefore, the plasticizer can be locally added only to that portion of the sheet material which needs to be increased in hardness. Thus, it is possible to prevent tow from projecting from the surface of the through hole without the need to use a large amount of the plasticizer, and also the through hole can be prevented from being crushed when the filter rod is cut.

The spray nozzle is attached to the end portion of the mandrel, and therefore, the spray nozzle and the mandrel form a unit and can be handled with ease. Also, since the mandrel is aligned with the axis of the forming tube, the second plasticizer sprayed from the spray nozzle can be directed accurately from the axis of the forming tube outward. The second plasticizer can therefore be reliably added to the portion which is to form the surface of the through hole.

Also, since the second plasticizer is sprayed from the spray nozzle radially in the forward direction of the tubular forming path, the plasticizer can be accurately and reliably added to the portion which is to form the surface of the through hole of the hollow continuous filter body. By restricting the spraying direction to the forward direction, the amount of usage of the second plasticizer can be further reduced.

Steam is applied to the sheet material through the hole formed through the peripheral wall of the forming tube, whereby the sheet material can be smoothly subjected to heat treatment.

Application of the second plasticizer enables efficient hardening of the sheet material.

Since the tubular forming path is configured such that the diameter of an inlet section thereof gradually increases toward the inlet of the forming path, the sheet material can easily enter the forming path, thus improving productivity.

The second plasticizer is locally sprayed only on that portion of the sheet material which is to form the surface of the through hole of the hollow filter. It is therefore possible to prevent the tow from projecting from the surface of the through hole without the need to use a large amount of the plasticizer, and also the through hole can be prevented from being crushed when the filter rod is cut.

Where the mandrel is configured to spout the second plasticizer directly therefrom, the second plasticizer can be locally and efficiently added to the portion which is to form the surface of the through hole of the hollow filter.

### BRIEF DESCRIPTION OF THE DRAWINGS

FIG. 1 schematically illustrates a filter manufacturing machine according to the present invention.

FIG. 2 is a schematic enlarged view of a forming device.

FIG. 3 is a schematic sectional view of another exemplary mandrel.

### MODE OF CARRYING OUT THE INVENTION

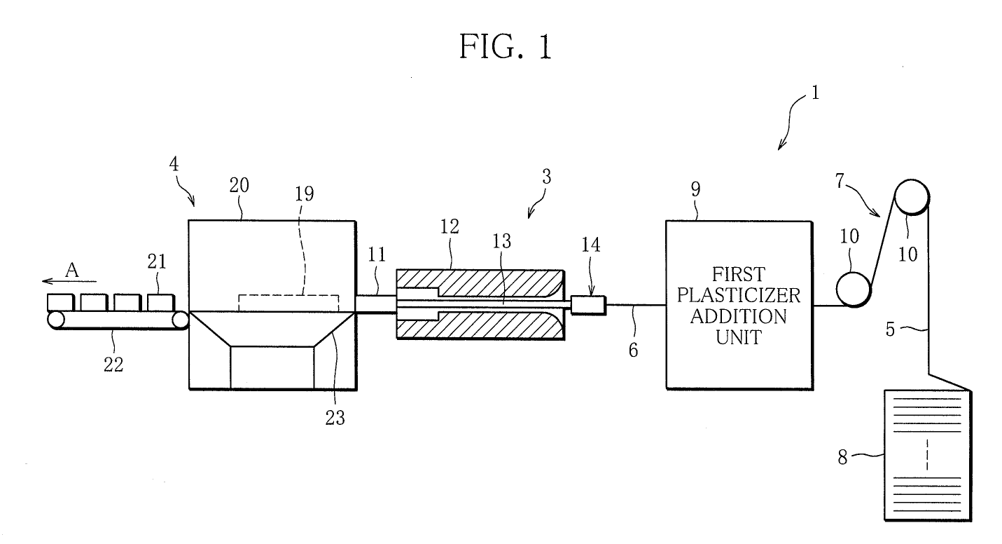

A filter manufacturing machine 1 illustrated in FIG. 1 includes a feed path 7, a forming device 3, and a wrapping device 4. The feed path 7 continuously conveys filter fibers (tow) 5 and a sheet material 6 containing the filter fibers 5. A storage vessel 8 storing the filter fibers 5, for example, cellulose acetate fibers, is arranged at a starting end of the feed path 7. The feed path 7 includes a plurality of (in the figure, two) guide rollers 10 and is connected to the forming device 3, described later. Also, the feed path 7 is provided with a first plasticizer addition unit 9. The first plasticizer addition unit 9 includes a conventionally known banding jet, a pair of pretension rollers and a pair of brooming rollers (none of which is shown), whereby the filter fibers 5 are opened and then formed into a sheet material. Further, the first plasticizer addition unit 9 is provided with a conventionally known sprayer (not shown) for adding a first plasticizer to the sheet material. As a result, the sheet material 6 is hardened to some extent.

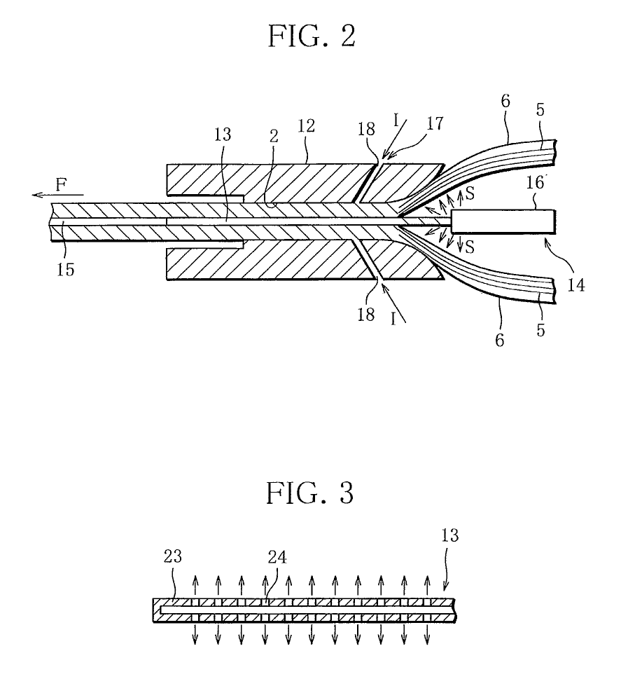

The feed path 7 is connected at its terminating end to the forming device 3 for forming the sheet material 6 into a hollow rod-shaped continuous filter body 11. As is clear from FIG. 2, the forming device 3 includes a forming tube 12, a mandrel 13, and a second plasticizer addition unit 14. The forming tube 12 is in the form of a hollow cylinder and allows the sheet material 6 to pass therethrough (in a direction indicated by arrow F in FIG. 2) while narrowing the sheet material 6. The sheet material 6 passes through a tubular forming path 2 in the forming tube 12. To stabilize the entry of the sheet material 6, the forming tube 12 may be configured such that an inlet section thereof has a gradually increasing inner diameter. Specifically, the tubular forming path 2 may have a rounded configuration such that the diameter thereof gradually increases toward the inlet. This makes it easier for the sheet material 6 to enter the tubular forming path 2, thereby improving productivity. A separate trumpet guide or the like may be used in order to obtain a similar effect. The mandrel 13 is arranged in alignment with the axis of the forming tube 12 and serves to make a through hole 15 in the continuous filter body 11. That is, the rod of filter fibers that has passed through the forming tube 12 has the through hole 15 corresponding in shape to the mandrel 13. The sheet material 6 is heat-treated in the forming tube 12 to be formed into the continuous filter body 11. The heat treatment is carried out by a heat treating section 17. In the illustrated example, the heat treating section 17 includes holes 18 formed through the peripheral wall of the forming tube 12, and steam is introduced through the holes 18 into the forming tube 12 (in directions indicated by arrows I in FIG. 2). Instead of steam, microwave or hot air may be used, or a different heat source such as electrically heated wire may be used.

The second plasticizer addition unit 14 is arranged near the inlet of the forming tube 12 and spouts a second plasticizer radially (in directions indicated by arrows S in FIG. 2) from the axis of the forming tube 12. Thus, the forming tube 12 is associated with the second plasticizer addition unit 14, and since the second plasticizer is spouted radially outward from the axis of the forming tube 12, the second plasticizer can be locally applied only to the inside of the sheet material 6 being fed into the forming tube 12. That is, the second plasticizer is added only to that portion of the sheet material 6 which later constitutes the surface of the through hole 15 of the continuous filter body 11 with the aid of the mandrel 13. Accordingly, only the surface of the through hole 15 of the continuous filter body 11 can be appropriately hardened, making it possible to reliably prevent the filter fibers from projecting from the surface of the through hole 15. Also, since the plasticizer is added only locally, an overall amount of usage of the plasticizer can be reduced, thus contributing to saving of resources. The continuous filter body 11 is thereafter wrapped in wrapping paper to obtain a filter rod, as described later, and when the filter rod is cut into filter plugs, the through hole 15 can be reliably prevented from being crushed at the cut ends of the filter plugs. In this manner, the second plasticizer addition unit 14 for adding the second plasticizer to the sheet material 6 is provided separately from the first plasticizer addition unit 9 for adding the first plasticizer, and it is therefore possible to locally add the plasticizer only to that portion of the sheet material 6 which needs to be increased in hardness. Also, dissolution of the filter fibers, which occurs when a large amount of plasticizer is used, can be prevented. The second plasticizer is added to the sheet material before the sheet material passes the heat treating section 17.

The mandrel 13 has one end portion located near the inlet of the forming tube 12, and a spray nozzle 16 of the second plasticizer addition unit 14 is attached to that end portion of the mandrel 13. The second plasticizer is sprayed from the spray nozzle 16. Since the spray nozzle 16 is attached to the end portion of the mandrel 13, the spray nozzle 16 and the mandrel 13 form a unit and can be handled with ease. Also, since the mandrel 13 is aligned with the axis of the forming tube 12, the second plasticizer sprayed from the spray nozzle 16 attached to the mandrel 13 can be directed accurately from the axis of the forming tube 12 outward. The second plasticizer can therefore be reliably added to the portion which is to form the surface of the through hole 15. Where the spray nozzle 16 is configured such that the second plasticizer is sprayed in a forward direction of the forming tube 12 in which the filter material advances within the forming tube 12, the second plasticizer can be accurately and reliably added to the portion which is to form the surface of the through hole 15 of the hollow continuous filter body. Also, where the direction of spraying the plasticizer is restricted to the forward direction of the forming tube 12, the amount of usage of the plasticizer can be further reduced.

The second plasticizer addition unit 14 may alternatively be configured as illustrated in FIG. 3. Specifically, a hollow mandrel 13 is used, and the second plasticizer is introduced into the mandrel 13 so as to be spouted from jet holes 24 formed through a peripheral wall 23 of the mandrel 13, in directions indicated by arrows in FIG. 3. Since the second plasticizer is spouted directly from the mandrel 13, it is possible to add the second plasticizer efficiently and locally to the portion which is to form the surface of the through hole of the hollow filter.

The wrapping device 4 includes a rod forming section 20, where the continuous filter body 11 is cut to a predetermined length on a table 23, the resulting filter section is wrapped in wrapped paper (not shown) to form a filter rod 19, and the filter rod 19 is cut by a cutter (not shown) to obtain filter plugs 21. These steps are executed by using equipment conventionally known in the art. The filter plugs 21 are then supplied to a subsequent process (in a direction indicated by arrow A in FIG. 1) by a garniture belt 22.

### EXPLANATION OF REFERENCE SIGNS

1 filter manufacturing machine
2 tubular forming path
3 forming device
4 wrapping device
5 filter fiber
6 sheet material
7 feed path
8 storage vessel
9 first plasticizer addition unit
10 guide roller
11 continuous filter body
12 forming tube
13 mandrel
14 second plasticizer addition unit
15 through hole
16 spray nozzle
17 heat treating section
18 hole
19 filter rod
20 rod forming section
21 filter plug
22 garniture belt
23 peripheral wall
24 jet hole

1. A filter manufacturing machine comprising:
a feed path configured to continuously feed a sheet material containing filter fibers;
a first plasticizer addition unit arranged in the feed path and configured to add a first plasticizer to the sheet material on the feed path;
a forming device connected to a terminating end of the feed path and configured to form the sheet material into a hollow rod-shaped continuous filter body and deliver the formed continuous filter body, the forming device including a tubular forming path allowing the sheet material to pass therethrough while narrowing the sheet material to form the sheet material into the continuous filter body, a heat treating section configured to heat the sheet material while the sheet material passes through the tubular forming path, and a second plasticizer addition unit arranged near an inlet of the tubular forming path and configured to spout a second plasticizer radially from an axis of the tubular forming path to add the second plasticizer to the sheet material; and
a wrapping device configured to receive the continuous filter body delivered from the forming device, wrap the continuous filter body in a wrapper to form a filter rod, and cut the filter rod to obtain filter plugs.

2. The filter manufacturing machine according to claim 1, wherein:
the forming device further includes a forming tube and a mandrel arranged inside the forming tube and cooperating with the forming tube to constitute the tubular forming path, the mandrel having one end portion located near an inlet of the forming tube, and
the second plasticizer addition unit has a spray nozzle attached to the one end portion of the mandrel to spray the second plasticizer from the spray nozzle.

3. The filter manufacturing machine according to claim 2, wherein the second plasticizer is sprayed from the spray nozzle in a forward direction of the tubular forming path.

4. The filter manufacturing machine according to claim 3, wherein the forming tube has a peripheral wall through which a hole is formed to supply steam to the sheet material from outside of the forming tube.

5. The filter manufacturing machine according to claim 4, wherein the spray nozzle is located upstream of the hole for supplying the steam, with respect to a direction in which the sheet material passes.

6. The filter manufacturing machine according to claim 1, wherein the tubular forming path has a rounded configuration such that a diameter of an inlet section thereof gradually increases toward the inlet of the tubular forming path.

7. The filter manufacturing machine according to claim 2, wherein the second plasticizer is sprayed only on a portion of the sheet material which comes into contact with the mandrel.

8. The filter manufacturing machine according to claim 1, wherein:
the forming device includes a forming tube and a mandrel arranged inside the forming tube and cooperating with the forming tube to constitute the tubular forming path, and
the mandrel includes a plasticizer flow channel axially extending therein to allow the second plasticizer to flow therein, a peripheral wall defining the plasticizer flow channel, and a plurality of jet holes formed through the peripheral wall to spout the second plasticizer therethrough.
